(19) United States
(12) Patent Application Publication
(10) Pub. No.: US 2026/0282176 A1
(43) Pub. Date: Sep. 17, 2026

(54) ADJUSTABLE INTERLOCK SYSTEM

(71) Applicant: WHIRLPOOL CORPORATION, BENTON HARBOR, MI (US)

(72) Inventors: Guoqing Lei, Guangdong (CN); Simone Polvara, Milan (IT)

(73) Assignee: WHIRLPOOL CORPORATION, BENTON HARBOR, MI (US)

(21) Appl. No.: 19/473,010

(22) PCT Filed: Apr. 6, 2023
(86) PCT No.: PCT/CN2023/086484

§ 371 Date: Oct. 6, 2025

(51) Int. Cl. H05B 6/64

(52) U.S. Cl. CPC H05B 6/6417

(57) ABSTRACT

An interlock mechanism for an appliance door includes a support plate defining a receipt path for a latch connected with the appliance door, a cam rotatably coupled with the support plate, defining a detent along a surface thereof, and moveable with respect to the receipt path between a release configuration and a retention configuration by movement of the latch into the receipt path. The mechanism further includes a mounting base coupled with the support plate so as to be moveable toward and away from the surface of the cam and a microswitch coupled with the mounting base and having a button exposed thereon such that moving the mounting base adjusts a threshold position at which the detent operably moves the button during rotation of the cam.

### CROSS REFERENCE TO RELATED APPLICATION

This application is a national stage application, filed under 35 U.S. C § 371, of International Patent Application No. PCT/CN2023/086484, filed on 6 Apr. 2023, which is incorporated by reference herein in its entirety.

### BACKGROUND OF THE DISCLOSURE

The present disclosure generally relates to an interlock mechanism for an appliance door, and more specifically, to an interlock mechanism with an adjustable switch position.

### SUMMARY OF THE DISCLOSURE

According to one aspect of the present disclosure, an interlock mechanism for an appliance door includes a support plate defining a receipt path for a latch connected with the appliance door, a cam rotatably coupled with the support plate, defining a detent along a surface thereof, and moveable with respect to the receipt path between a release configuration and a retention configuration by movement of the latch into the receipt path. The mechanism further includes a mounting base coupled with the support plate so as to be moveable toward and away from the surface of the cam and a microswitch coupled with the mounting base and having a button exposed thereon such that moving the mounting base adjusts a threshold position at which the detent operably moves the button during rotation of the cam.

According to another aspect of the present disclosure, a cooking appliance includes a housing defining an interior with an open side, a door coupled with the housing and movable to selectively close the open side of the interior, a latch coupled with the door on an interior side thereof, and an interlock mechanism. The interlock mechanism includes a support plate mounted within the housing and defining a receipt path for the latch, a cam rotatably coupled with the support plate, defining a detent along a surface thereof, and moveable with respect to the receipt path between a release configuration and a retention configuration by movement of the latch into the receipt path. A mounting base is coupled with the support plate so as to be moveable toward and away from the surface of the cam, and a microswitch is coupled with the mounting base and has a button exposed thereon such that moving the mounting base adjusts a threshold position of the cam at which the detent operably moves the button during rotation of the cam.

According to yet another aspect of the present disclosure, an interlock mechanism for an appliance door includes a support plate defining a receipt path for a latch connected with the appliance door, a cam rotatably coupled with the support plate, defining a detent along a surface thereof and moveable with respect to the receipt path between a release configuration and a retention configuration by movement of an appliance door latch into the receipt path. The cam is configured for bi-stable movement wherein the cam is urged toward a first end position, within the release configuration, and a second end position, within the retention position, when positioned on respective first and second sides of a breakover point. A microswitch has a button exposed thereon and is moveably coupled with the support plate to adjust a threshold position of the cam at which the detent operably moves the button during rotation of the cam and is moveable toward and away from the surface of the cam so as to define a range of adjustment of the threshold position that is between the breakover position and the second end position.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a side perspective view of a microwave oven including an interlock mechanism according to an aspect of the disclosure;

FIG. 2 is a front perspective view of the microwave oven including an interlock mechanism of FIG. 1 with the door thereof in an open position;

FIG. 3 is a cross section view of the microwave oven of FIG. 1, taken along line III-Ill in FIG. 1 and showing examples of the interlock mechanism according to the present disclosure;

FIG. 4 is a side view of the interlock mechanism according to an aspect of the disclosure in a release configuration;

FIG. 5 is a detail view of the interlock mechanism retaining a door latch in a retention configuration;

FIG. 6 is a detail view of the interlock mechanism with the door moved into a slightly open position while the interlock mechanism remains in the retention configuration;

FIG. 7 is a perspective assembly view of the interlock mechanism;

FIG. 8 a perspective view of the interlock mechanism;

FIG. 9 is a cross section view taken along the line IX-IX in FIG. 8 showing an adjustment mechanism for a switch position of the interlock mechanism;

FIG. 10 is a side view of the microwave oven of FIG. 1 during an assembly and adjustment state thereof; and

FIG. 11 is a perspective view of the microwave oven during the assembly and adjustment state.

The components in the figures are not necessarily to scale, emphasis instead being placed upon illustrating the principles described herein.

### DETAILED DESCRIPTION

The present illustrated embodiments reside primarily in combinations of method steps and apparatus components related to an interlock mechanism for an appliance. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

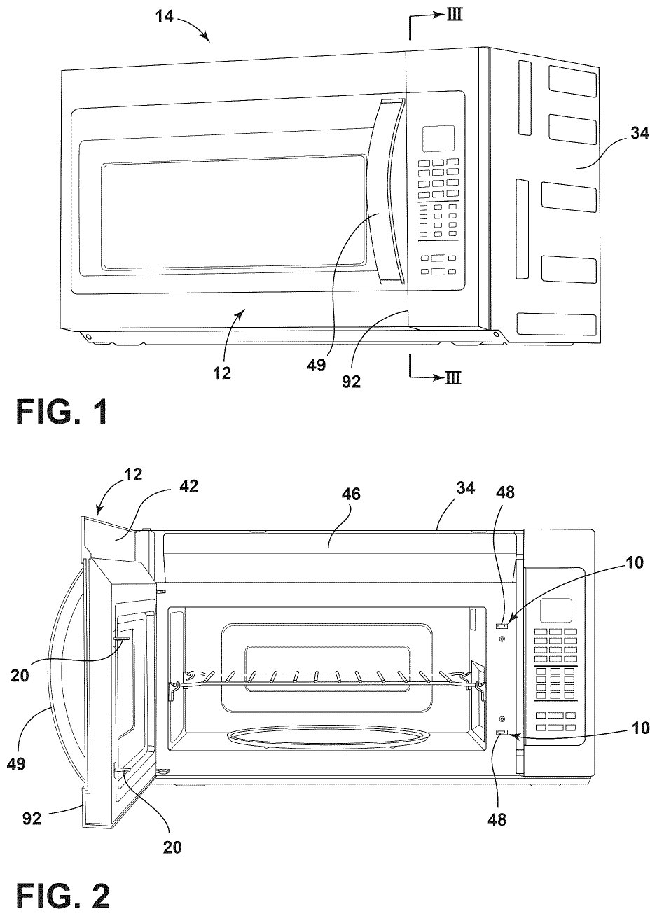

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer, and the term “rear” shall refer to the surface of the element further from the intended viewer. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

Ordinal modifiers (i.e., “first”, “second”, etc.) may be used to distinguish between various structures of a disclosed article in various contexts, but that such ordinals are not necessarily intended to apply to such elements outside of the particular context in which they are used and that, in various aspects different ones of the same class of elements may be identified with the same, context-specific ordinal. In such instances, other particular designations of the elements are used to clarify the overall relationship between such elements. Ordinals are not used to designate a position of the elements, nor do they exclude additional, or intervening, non-ordered elements or signify an importance or rank of the elements within a particular class.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

For purposes of this disclosure, the terms “about”, “approximately”, or “substantially” are intended to mean that a value of a parameter is close to a stated value or position. However, minor differences may prevent the values or positions from being exactly as stated. Thus, unless otherwise noted, differences of up to ten percent (10%) for a given value are reasonable differences from the ideal goal of exactly as described. In many instances, a significant difference can be when the difference is greater than ten percent (10%), except as where would be generally understood otherwise by a person of ordinary skill in the art based on the context in which such term is used.

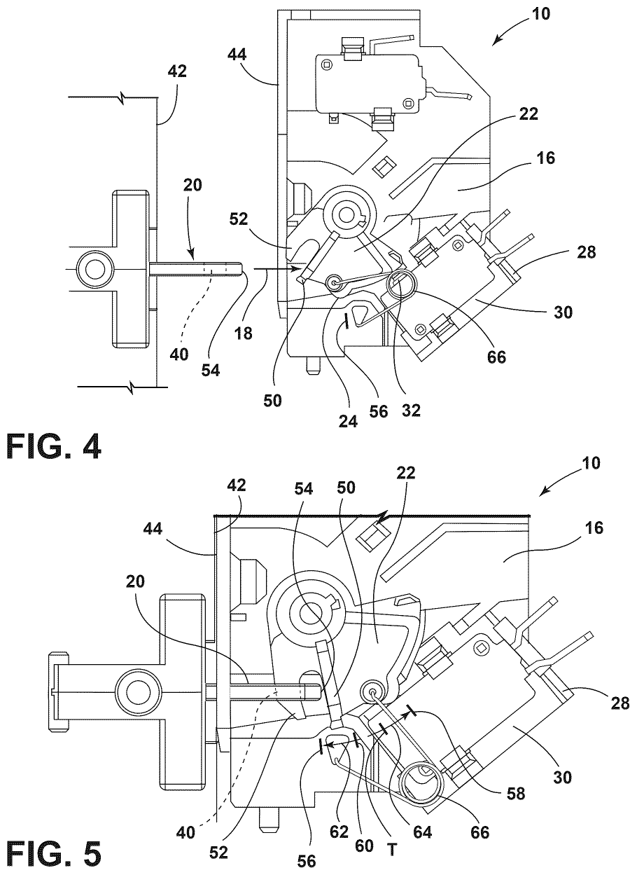

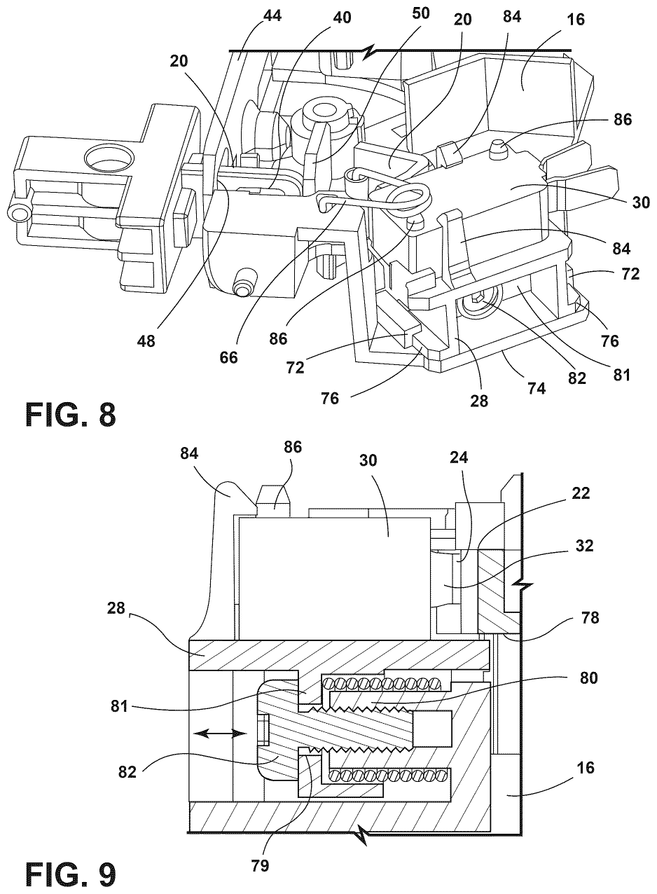

Referring to FIGS. 1-10, reference numeral 10 generally designates an interlock mechanism operably associated with the door 12 of an appliance 14. Interlock mechanism 10 includes a support plate 16 defining a receipt path 18 for a latch 20 connected with the door 12, a cam 22 rotatably coupled with the support plate 16, defining a detent 24 along a surface 26 thereof, and moveable with respect to the receipt path 18 between a release configuration (FIG. 4) and a retention configuration (FIG. 5) by movement of the latch 20 into the receipt path 18. The mechanism 10 further includes a mounting base 28 coupled with the support plate 16 so as to be moveable toward and away from the surface 26 of the cam 22 and a microswitch 30 coupled with the mounting base 28 and having a button 32 exposed thereon such that moving the mounting base 28 adjusts a threshold position T of the cam 22 at which the detent 24 operably contacts the button 32 during rotation of the cam 22. In this respect, it is noted that the discussion of the detent 24 “operably” moving the button 32 is not necessarily limited to the point of physical contact between the detent 24 and the button 32 or general movement, initial or otherwise, of the button 32 by the detent 24, but is intended to refer to the point at which movement of the button 32 by the detent 24 causes electromechanical operation of the button 32. In most instances, this electromechanical operation will occur by appreciable movement of the button with respect to the remaining microswitch 30, but the particular amount of movement needed to cause such operation may vary depending on the particular implementation or variation of the subject microswitch 30. Accordingly, the “threshold” position CP, referred to herein is intended to correspond with the relative positioning of elements when such operable movement occurs made.

As shown in FIGS. 1-3, in particular, the appliance 14 is a cooking appliance, and more particularly, is a microwave oven 14 that includes a housing 34 defining an interior 36 with an open side 38. A door 12 is coupled with the housing 34 and is movable to selectively close over the open side 38 of the interior 36 and openable to allow access to the interior 36 through the open side 38. In this manner, the above-described latch 20 is coupled with the door 12 on an inside surface 42 with the interlock mechanism 10 mounted within the housing 34 outside of the interior 36 and adjacent the open side 38. More particularly, the interlock mechanism can be mounted on an interior of the front face 44 of the housing 34 so as to be disposed within a mechanical compartment 46 of the microwave oven 14 that is separated from the interior 36. The latch 20 can move into the receipt path 18 for engagement with the cam 22, as discussed further below, by way of an aperture 48 through the front face 44 that aligns with the receipt path 18.

It is to be appreciated that, in one aspect, the present interlock mechanism 10 is configured to engage with the latch to maintain the door 12 in the closed position shown in FIG. 1, while allowing a generally deliberate amount of force applied, for example, to the door handle 49 to open the door 12 by releasing the interlock mechanism 10. In this respect, as shown in FIGS. 4 and 5, the cam 22 includes a lever portion 50 and a hook portion 52 and is configured to move from the release configuration (FIG. 4) into the retention configuration (FIG. 5) by movement of the latch 20 into the receipt path 18 under contact of a leading surface 54 of the latch 20 against the lever portion 50 such that hook portion 52 moves into an opening 40 in the latch 20 past the leading surface 54 to retain the door 12 in the closed position over the open side 38 of the interior 36.

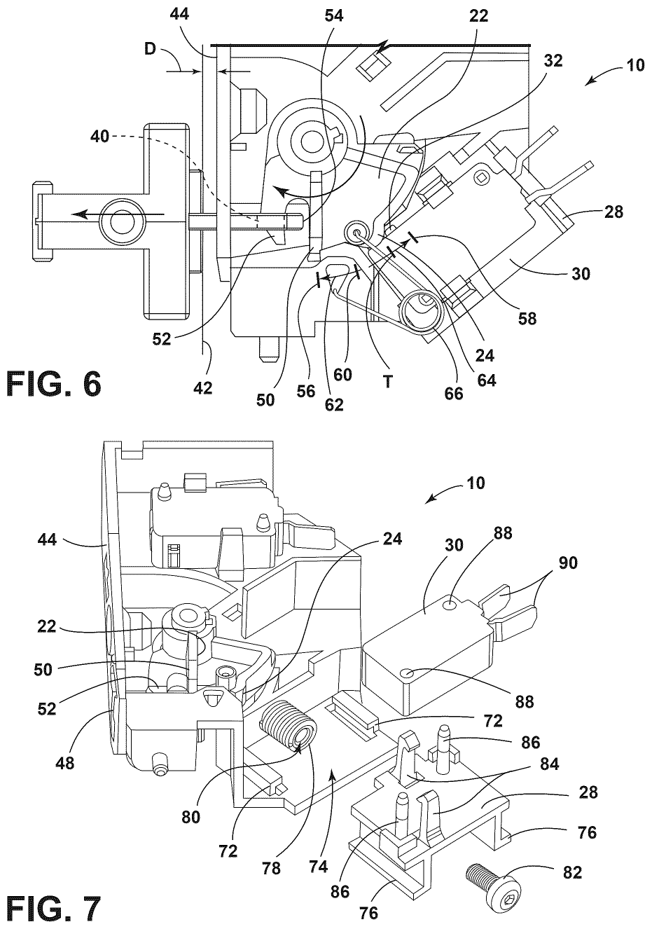

To achieve this behavior, the cam 22 can be configured for bi-stable movement wherein it is urged toward a first end position 56, within the release configuration, and a second end position 58, within the retention configuration, when the cam 22 is positioned on respective first 62 and second 64 sides of a breakover point 60. It is noted that, as shown in FIGS. 5 and 6, the various positions of the cam 22 are indicated (and generally described herein) with reference to the respective locations of the detent 24 when the cam is in such positions; however, the positions discussed are not necessarily limited as such and may, as needed or convenient, be measured relative to other features of the cam 22. In the illustrated example, the bi-stable configuration is achieved by a torsion spring 66 included in the interlock mechanism 10 by being coupled between the cam 22 and the support plate 16 and configured to urge the cam 22 toward a respective one of the first end position 56 and the second end position 58 when the cam 22 is positioned on either the first side 62 or second side 64 of the breakover point 60. As shown, the torsion spring 66 is connected between the cam 22 and the support plate 16 such that it is compresses under movement from the from either the first end position 56 or the second end position 58 toward the breakover point 60, with a maximum compression of the torsion spring 66 corresponding with positioning of the cam 22 at the breakover point 60. In this manner, the torsion spring 66 extends with rotational movement of the cam 22 away from the breakover point 60 toward either of the first end position 56 and the second end position 58, thus urging the cam 22 toward such positions, depending on the respective side 62 or 64 on which the cam 22 is positioned. In this respect, the release configuration can be defined as a range of positions of the cam 22 on the first side 62 of the breakover point with the retention configuration being similarly defined by the cam 22 being within a range of positions on the second side 64 of the breakover point 60.

For desired operation of the interlock mechanism 10 in maintaining the door 12 in the closed position, the arrangement of the torsion spring 66 with respect to the cam 22 and the support plate 16 is such that the cam 22 is positioned between the breakover point 60 and the second end point 58 when the inside surface 42 of the door 12 contacts the front face 44 of the housing 34. In this manner, the torsion spring 66 continues to urge the cam 22 toward the second end point 58, thus causing the hook portion 52 of the cam 22 to exert an inward force on the latch 20 to maintain the inside surface 42 of the door 12 against the front face 44 under pressure with the door 12 in the closed position. As shown in FIG. 6, certain implementations of this arrangement may be such that the door 12 can be pulled open by a distance D before the cam 22 reaches the breakover point. While continued opening movement of the door 12 will cause the interlock mechanism 10 to move into the release configuration, allowing the door 12 to be fully opened, letting go of the door 12 in such a position will result in the interlock mechanism 10 returning the door 12 to the fully closed position, in which the inner surface 42 contacts the front face 44.

In the above-described arrangement, the microswitch 30 is included within the interlock mechanism 10 to be used by the appliance 14 in determining when the door 12 has been moved out of the fully-closed position shown in FIG. 5, including when the inside surface 42 of the door 12 is moved away from the front face 44 of the housing 34 but when the cam 22 has not yet reached the breakover point 60 to fully release the door 12. Such an arrangement may be particularly advantageous in connection with the depicted appliance in the form of a microwave 14, wherein micro-waves may escape through the small opening resulting from the door 12 being opened by a distance D in an undesired manner. In such an example, the microwave 14 further includes a magnetron 68 positioned within the mechanical compartment 46 and configured for providing micro-waves to the interior 36 and a controller 70 connected with the magnetron 68 and with the microswitch 30. In one aspect, the controller 70 is configured for controlling operation of the magnetron 68, including by deactivating the magnetron 68 when the detent 24 moves out of contact with button 32 of the microswitch 30. In further aspects, the controller 70 can require that the button 32 be depressed by contact by the detent 24 prior to operation and/or activation of certain modes, actions, or menu items. In these aspects, it may be desired to have the button 32 positioned relative to detent 24 (and the related motion path of detent 24) such that detent 24 moves out of contact with button (or at least allows the button 32 to move outward with respect to microswitch 30) when the door 12 is moved away from front face 44 by an amount smaller than the distance D at which the door 12 is released, and in some aspects by a predetermined amount at which microwave leak may occur, and in some aspects by as little as 0.1 mm, for example.

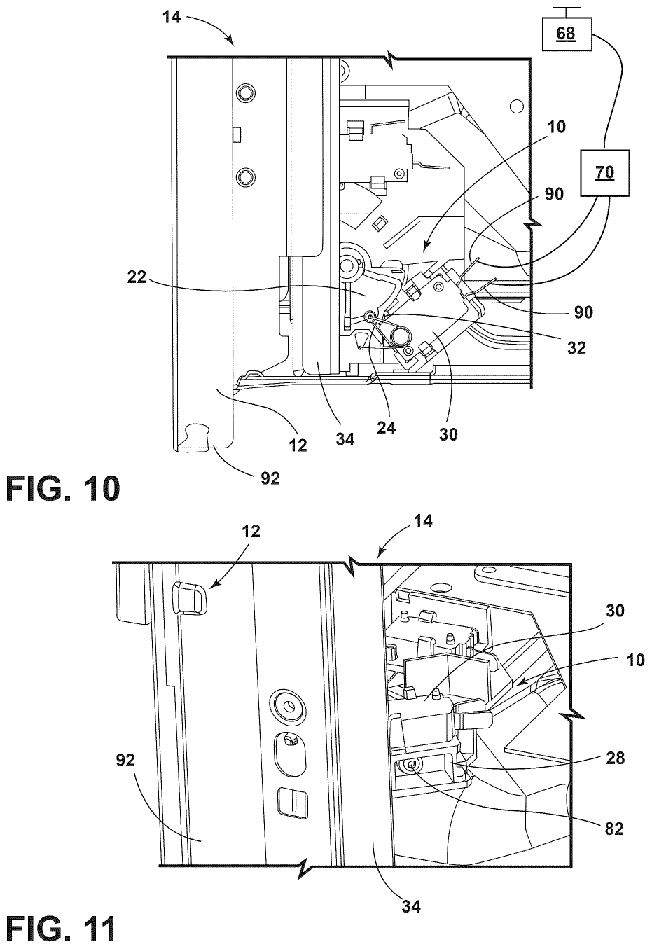

Because the relative positioning of the button 32 of the microswitch 30 is subject to tolerance stack up of the various components of the interlock mechanism 10, at least of cam 22 and support plate 16, as well as the assembly of the components and internal variations within microswitch 30, it may be desirable to configure the interlock mechanism 10, as shown in FIGS. 6-9, for adjustment of the position of microswitch 30 relative to cam 22. In this arrangement, the relative positioning between the button 32 and the detent 24 can be adjusted after assembly of the remainder of the interlock mechanism 10, including within the appliance 14 along with assembly of the door 12 (as shown in FIGS. 10 and 11). In this manner, it is possible to control and adjust the position of the microswitch 30 such that the threshold position T corresponds with door 12 being closed and that opening door, even by a small amount deactivates microswitch 30 by reverse operable movement of button 32. More particularly, the controller 70 can be connected with the magnetron 68 and with the microswitch 30 and can be configured for controlling operation of the magnetron 68 including deactivation of the magnetron 68 when the cam 22 moves away from the threshold position T toward the first end position 56. In this manner, the threshold position T may be adjustable so as to correspond with the above-described position of the cam 22 when the hook portion 52 retains the door 12 in the closed position. In particular, the mounting base 28 to which the microswitch 30 is coupled can be moveable toward and away from the surface 26 of cam 22 so as to define a range of adjustment of the switch threshold position T that is between the breakover position 60 and the second end position 58. More particularly, moving the mounting base 28 in direction M moves the button 32 closer to the surface 26 of cam 22 and, accordingly, moves the button 32 more directly into the path of the detent 24. Notably, as both the button 32 and the detent 24 are tapered in shape in directions mutually toward one another, this movement of the button 32 in direction D would move the contact point CP closer to the breakover point 60, with movement opposite direction D (i.e. outward away from the surface 26 of cam 22) moving the contact point CP toward the second end position 58. In this manner, moving the mounting base 28 adjusts the position of the cam 22 at which the detent 24 operably moves the button 32 during rotation of the cam 22 such that the threshold position T is adjusted to correspond with the door 12 being in the closed position and such that the detent 24 allows reverse movement of the button 32 when the door 12 is moved out of the closed position.

As particularly shown in FIGS. 7-9, the mounting base 28 is made moveable with respect to the support plate 16 by configuring the mounting base 28 for sliding attachment with the support plate 16. As shown in FIG. 7, the support plate 16 includes parallel tracks 72 along a mounting portion 74 thereof, with the tracks 72 being positioned to receive corresponding flanges 76 on the mounting base 28. In this manner, the mounting base 28 is slid into position on the mounting portion 74 of the support plate 16 with the flanges 76 slidably received in the tracks 72. A compression spring 78 is positioned around a threaded base 80 on the support plate 16 and facing the mounting portion 74. The compression spring 78 is configured to, at least at rest, extend outward pass the threaded base 80 to be captured between the support plate 16 and an interior face 81 of the mounting portion 74. A screw 82 can then be passed through a hole 79 in the interior face 81 to engage with the threads of the threaded base 80. In this manner, the screw 82 can secure the mounting base 28 to the support plate 16 at least by maintaining the flanges 76 in engagement with the tracks 72. In this arrangement, the spring 78 urges the mounting base 28 outward away from the threaded base 80 such that the screw 82 can be turned into the threaded base 80 to move the mounting base 28 inward against the force of the compression spring 78 to adjust the position of the mounting base 28. In a similar manner, once moved inward, the screw 82 can be loosened to move the mounting base 28 back outward for opposite adjustment of the mounting base 28.

As further shown, the mounting base 28 is configured to receive the microswitch 30 by way of a plurality of snap-fit arms 84 that capture the microswitch 30. The microswitch 30 is further maintained in a desired location on the mounting base 28 by a plurality of pegs 86 that align with holes 88 in the microswitch 30. In this manner, the above-described movement of the mounting base 28 with respect to the support plate 16 moves the microswitch 30 with respect to the cam 22, which is coupled with the support plate 16, as discussed above. In one aspect of this arrangement, moving the mounting base 28 away from the surface cam 22 adjusts the threshold position T in an inward direction relative to the receipt path 18. The described movement of the microswitch 30 by way of the adjustment of screw 82 results in an arrangement by which the screw 82 is accessible to an operator during assembly of the appliance 14. As shown in FIGS. 10 and 11, the interlock mechanism may be assembled with the front face 40 (either directly or indirectly), with the door 12 being similarly coupled with the front face 40 (such as by way of hinges that may attach with the front face 44, with an internal frame, or the like). This can be done, for example, before completing the assembly of the housing 34 (such as with a rear and/or side cover not yet installed) such that the door 12 can be closed, including by engagement of the latch 20 with the interlock mechanism 10. The operator can then assess the relative positioning of the button 32 with respect to the detent 24 in the fully closed position and during outward manipulation of the door 12 relative to the breakover point 60. The screw 82 can then be manipulated to move the microswitch 30 such that the appropriate threshold position T is achieved before the housing 34 is completed and/or enclosed. The assessment of the threshold position T can be made visually or by way of an electronic apparatus connected with microswitch 30 by way of electrical contacts 90.

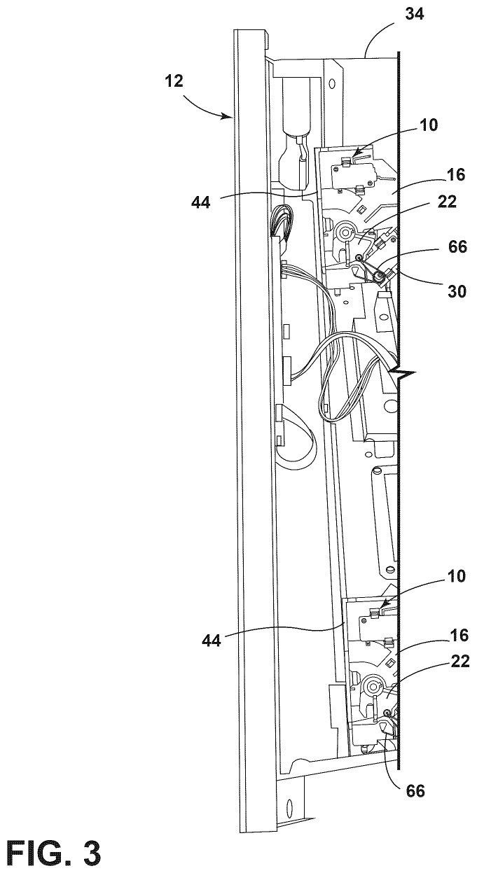

Returning to FIG. 3, the interlock mechanism 10 described herein may be one of a plurality of such interlock mechanisms 10 included with the appliance 14. In the illustrated example, two such interlock mechanisms 10 can be included adjacent the free end 92 of the door 12 in a vertically-spaced arrangement. Accordingly, the door 12 can include two latches 20, each associated with a respective interlock mechanism 10 via a respective aperture 48 in the front face 44. Each interlock mechanism 10 can include a microswitch 30 configured, as above to indicate opening of the door 12 (including by way of the above-described adjustment), particularly, as force applied unevenly along the free end 92 (i.e. relative to the vertical direction) may result in the door 12 becoming open at either the bottom or top corner before the other. Additionally, each of the interlock mechanisms 10 can be secondary interlock mechanisms, with the position data indicated by the microswitches 30 providing supplemental position data to supplement that which may be provided by the primary interlock, which may be operably associated with the door hinges or may be a separate switch with a separate actuation mechanism according to known arrangements.

It will be understood by one having ordinary skill in the art that construction of the described disclosure and other components is not limited to any specific material. Other exemplary embodiments of the disclosure disclosed herein may be formed from a wide variety of materials, unless described otherwise herein.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. An interlock mechanism for an appliance door, comprising:
a support plate defining a receipt path for a latch connected with the appliance door;
a cam rotatably coupled with the support plate, defining a detent along a surface thereof, and moveable between a release configuration and a retention configuration by movement of the latch into the receipt path;
a mounting base coupled with the support plate so as to be moveable toward and away from the surface of the cam; and
a microswitch coupled with the mounting base and having a button exposed thereon such that moving the mounting base adjusts a threshold position at which the detent operably moves the button during rotation of the cam.

2. The interlock mechanism of claim 1, further including:
a compression spring positioned between the support plate and the mounting base to urge the mounting base outward; and
a screw to adjust the mounting base position inward, against a force of the spring.

3. The interlock mechanism of claim 1, wherein moving the mounting base away from the cam adjusts the threshold position in an inward direction relative to the receipt path.

4. The interlock mechanism of claim 1, wherein the cam is configured for bi-stable movement, wherein the cam is urged toward a first end position, within the release configuration, and a second end position, within the retention configuration, when positioned on respective first and second sides of a breakover point.

5. The interlock mechanism of claim 4, further including a torsion spring coupled between the cam and the support plate and configured to urge the cam toward a respective one of the first end position and the second end position when the cam is positioned on either the first side or second side of the breakover point.

6. The interlock mechanism of claim 5, wherein the mounting base is moveable toward and away from the surface of the cam so as to define a range of adjustment of the threshold position that is between the breakover point and the second end position.

7. The interlock mechanism of claim 1, wherein the cam includes a lever portion and a hook portion and is configured to move from the release configuration into the retention configuration by movement of the latch into the receipt path under contact of a leading surface of the latch against the lever portion such that hook portion moves into an opening in the latch past the leading surface.

8. The interlock mechanism of claim 7, wherein:
the latch is coupled to the appliance door such that the hook portion retains door closed; and
the threshold position is adjustable so as to correspond with a position of the cam when the hook portion retains the door in a closed position.

9. A cooking appliance, comprising:
a housing defining an interior with an open side;
a door coupled with the housing and movable to selectively close the open side of the interior, a latch being coupled with the door on an interior side thereof; and
an interlock mechanism, including:
a support plate mounted within the housing and defining a receipt path for the latch;
a cam rotatably coupled with the support plate, defining a detent along a surface thereof, and moveable between a release configuration and a retention configuration by movement of the latch into the receipt path;
a mounting base coupled with the support plate so as to be moveable toward and away from the surface of the cam; and
a microswitch coupled with the mounting base and having a button exposed thereon such that moving the mounting base adjusts a threshold position at which the detent operably contacts the button during rotation of the cam.

10. The cooking appliance of claim 9, wherein the cam includes a lever portion and a hook portion and is configured to move from the release configuration into the retention configuration by movement of the latch into the receipt path under contact of a leading surface of the latch against the lever portion such that hook portion moves into opening in latch past the leading edge to retain the door in a closed position over the open side of the interior.

11. The cooking appliance of claim 10, wherein the threshold position is adjustable so as to correspond with a position of the cam when the hook portion retains the door in a closed position.

12. The cooking appliance of claim 9, wherein the cam is configured for bi-stable movement wherein the cam is urged toward a first end position, within the release configuration, and a second end position, within the retention configuration, when positioned on respective first and second sides of a breakover point.

13. The cooking appliance of claim 12, further including a torsion spring coupled between the cam and the support plate and configured to urge the cam toward a respective one of the first end position and the second end position when the cam is positioned on either the first side or second side of the breakover point.

14. The cooking appliance of claim 13, wherein the mounting base is moveable toward and away from the surface of the cam so as to define a range of adjustment of the threshold position that is between the breakover position and the second end position.

15. The cooking appliance of claim 12, wherein the cam is configured to engage with the latch when in the retention configuration and to retain the door in the closed position without reaching the second end position.

16. The cooking appliance of claim 15, wherein moving the mounting base adjusts position of the cam at which the detent operably moves the button during rotation of the cam such that the threshold position is adjusted to correspond with the door being in the closed position and such that the detent allows reverse movement of the microswitch when the door is moved out of the closed position.

17. The cooking appliance of claim 16, further including:
a magnetron configured for providing micro waves to the interior; and
a controller connected with the magnetron and with the microswitch and configured for controlling operation of the magnetron including deactivation of the magnetron when the cam moves away from the threshold position toward the first end position.

18. An interlock mechanism for an appliance door, comprising:
a support plate defining a receipt path for a latch connected with the appliance door;
a cam rotatably coupled with the support plate, defining a detent along a surface thereof, and moveable with respect to the receipt path between a release configuration and a retention configuration by movement of an appliance door latch into the receipt path, wherein the cam is configured for bi-stable movement wherein the cam is urged toward a first end position, within the release configuration, and a second end position, within the retention position, when positioned on respective first and second sides of a breakover point;
a microswitch coupled having a button exposed thereon and moveably coupled with the support plate to adjust a threshold at which the detent operably contacts the button during rotation of the cam, the microswitch being moveable toward and away from the surface of the cam so as to define a range of adjustment of the threshold position that is between the breakover position and the second end position.

19. The interlock mechanism of claim 18, further including a torsion spring coupled between the cam and the support plate and configured to urge the cam toward a respective one of the first end position and the second end position when the cam is positioned on either the first side or second side of the breakover point.

20. The interlock mechanism of claim 18, wherein the cam includes lever portion and hook portion and is configured to move from the release configuration into the retention configuration by movement of the latch into the receipt path under contact of a leading surface of the latch against the lever portion such that hook portion moves into an opening in the latch past the leading edge.
